(19) United States
(12) Patent Application Publication
(10) Pub. No.: US 2006/0291811 A1
(43) Pub. Date: Dec. 28, 2006

(54) Moving picture distribution system

(76) Inventors: Yousuke Suzuki, Osaka (JP); Takahiro Nagai, Osaka (JP); Makoto Takano, Shiga (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/596,607

(22) PCT Filed: Dec. 14, 2004
(86) PCT No.: PCT/JP04/18637

§ 371 Date: Jun. 19, 2006

(30) Foreign Application Priority Data
Dec. 19, 2003 (JP) 2003422508
Aug. 24, 2004 (JP) 2004243350

(51) Int. Cl. H04N 7/00

(52) U.S. Cl. 386/95

(57) ABSTRACT

When a server device records a portion of a movie after a client device has started a streaming playback, the client device is allowed to make a special playback of that movie. The server device includes: a video recording processing section for recording a movie and generating movie data, made up of predetermined data units, and management information in which a playback duration and a data size are associated with each other for each unit; a storage medium to store the movie data and management information; a receiving section, which receives a request to get the management information and a request to transmit the data unit from the client device; a request processing section for reading the management information and data unit in response to the requests and instructing their transmission; and a transmitting section for transmitting them. If the request to transmit has been received after the management information was transmitted, the request processing section instructs that at least a piece of the newest management information be transmitted with the unit selected by the request to transmit.

### TECHNICAL FIELD

The present invention relates to a technique of realizing a special type of movie playback operation such as fast forward playback or fast rewind operation. More particularly, the present invention relates to a technique of enabling a client device, which is doing a streaming playback of a movie that is being recorded by a server device in a network environment, to make such a special type of playback operation.

### BACKGROUND ART

Recently, devices for recording a telecast program, for example, on a hard disk or an optical disk have become increasingly popular. Hard disks and optical disks are randomly accessible storage media. By utilizing such capability, the majority of those devices allow the user to record a program and play back, watch and listen to recorded portions of that program at the same time.

Some of those devices have a server function, i.e., the function of distributing movie data to other devices when connected to a network. A device with such a server function will be referred to herein as a “server device”, while a device that receives the distributed program data will be referred to herein as a “client device”. The client device can play back a movie while receiving the data of the movie from a server device over a network. A playback operation of this type will be referred to herein as a “streaming playback operation”.

The client device can also do a streaming playback of a recorded movie that is stored on the server device. This streaming playback includes special types of playback operations such as a fast forward playback and a fast rewind playback. For example, Patent Document No. 1 discloses a technique of enabling a special playback while carrying out a streaming playback over a network. According to the technique disclosed in Patent Document No. 1, the server device records a movie on a hard disk and then analyzes the movie, generates management information that is needed to make a special playback, and stores that information on the HDD, too. In doing a streaming playback of the movie, the client device gets the management information from the server device in advance and then gets the movie data from the server device by reference to the management information got. Thus, even if a special playback were carried out during a streaming playback, the storage capacity of a memory for accumulating the movie data can be reduced on the client device side.
Patent Document No. 1: Japanese Patent Application Laid-Open Publication No. 2003-46928

### DISCLOSURE OF INVENTION

Problems to be Solved by the Invention

According to the network movie playback method, however, it is impossible to make a special playback of portions of the movie that has been recorded after the movie data has started to be distributed. This is because the management information that was got by the client device does not include the management information of those portions of the movie that have been recorded after the movie started to be distributed. Consequently, according to this method, no special playback can be carried out while a streaming playback of a movie being recorded is being performed.

In addition, the management information includes description about the attributes of the movie such as the resolution thereof. Accordingly, if the attributes changed after the movie data started to be distributed, those portions of the movie that have been recorded after the movie started to be distributed could not be played back, either, which is also a problem.

Means for Solving the Problems

An object of the present invention is to enable a special playback of those portions of the movie that have been recorded after a streaming playback was started.

A server device according to the present invention is used with a client device in a movie distribution system. The server device includes: a video recording processing section for recording a movie and generating not only movie data, made up of predetermined data units, but also management information in which a playback duration and a data size are associated with each other with respect to each said data unit; a storage medium to store the movie data and the management information thereon; a receiving section, which receives a request to get the management information and a request to transmit the data unit from the client device; a request processing section for reading the management information and the data unit in response to the request to get and the request to transmit, respectively, and instructing that the management information and the data unit be transmitted; and a transmitting section for transmitting the management information and data unit selected. If the request to transmit the data unit has been received after the management information was transmitted, the request processing section instructs that at least a piece of the newest management information be transmitted with the data unit selected by the request to transmit.

The request processing section may instruct that a piece of the management information, which has been updated after the management information was transmitted and until the at least one data unit selected by the request to transmit is transmitted, be transmitted.

When the video recording processing section stops recording the movie, the request processing section may instruct that a notification of the stop of recording be sent and the transmitting section may send the notification with the data unit selected by the request to transmit.

The transmitting section may transmit at least two of: the data unit; at least the piece of the newest management information; and the notification, that are stored in separate sections of a message so as to be distinguished from each other.

The movie data may concern a stream compliant with one of the MPEG standards and the data unit may be a video object unit.

The video recording processing section may generate management information in which playback-related attributes of the movie are further associated with each said data unit.

A client device according to the present invention is used with a server device in a movie distribution system. The server device records a movie and stores not only movie data, made up of predetermined data units, but also management information in which a playback duration and a data size are associated with each other with respect to each said data unit. The client device includes: a transmitting section for sending the server device a request to get the management information and a request to transmit the data unit; a receiving section for receiving the management information and the data unit from the server device that has responded to the request to get and the request to transmit, respectively; a playback control section for finding a data unit that is needed to make a streaming playback by reference to the management information and instructing that the request to transmit be sent; and a movie output processing section for playing back the movie based on the data unit received. The receiving section receives not only the data unit but also at least the piece of the newest management information from the server device.

The receiving section may receive a piece of the management information, which has been updated after the server device transmitted the management information in response to the request to get and until the at least one data unit selected by the request to transmit is transmitted.

The receiving section may receive not only the data unit but also a notification of stop of recording from the server device.

The receiving section may receive a message, in which at least two of: the data unit; at least the piece of the newest management information; and the notification, are stored, and may identify and retrieve the at least two of them.

The movie data may concern a stream compliant with one of the MPEG standards and the data unit may be a video object unit.

The receiving section may receive management information in which playback-related attributes of the movie are further associated with each said data unit, and the movie output processing section may play back the movie in accordance with the attributes and the data units.

A movie distribution system according to the present invention allows a client device to receive movie data, made up of predetermined data units, from a server device and to make a streaming playback of the movie. The server device of the movie distribution system includes: a video recording processing section for recording a movie and generating not only movie data, made up of predetermined data units, but also management information in which a playback duration and a data size are associated with each other with respect to each said data unit; a storage medium to store the movie data and the management information thereon; a server receiving section, which receives a request to get the management information and a request to transmit the data unit from the client device; a request processing section for reading the management information and the data unit in response to the request to get and the request to transmit, respectively, and instructing that the management information and the data unit be transmitted; and a server transmitting section for transmitting the management information and data unit selected. The client device of the distribution system includes: a client transmitting section for sending the server device the request to get the management information and the request to transmit the data unit; a client receiving section for receiving the management information and the data unit from the server device that has responded to the request to get and the request to transmit, respectively; a playback control section for finding a data unit that is needed to make the streaming playback by reference to the management information and instructing that the request to transmit be sent; and a movie output processing section for playing back the movie based on the data unit received. If the request to transmit the data unit has been received after the management information was transmitted, the request processing section of the server device instructs that at least a piece of the newest management information be transmitted with the data unit selected by the request to transmit and the client receiving section receives not only the data unit but also at least the piece of the newest management information from the server device.

A method according to the present invention is carried out by a server device for use with a client device in a movie distribution system. The method includes the steps of: recording a movie and generating not only movie data, made up of predetermined data units, but also management information in which a playback duration and a data size are associated with each other with respect to each said data unit; storing the movie data and the management information; receiving a request to get the management information from the client device; transmitting the management information in response to the request to get; receiving a request to transmit the data unit that has been selected by the client device by reference to the management information transmitted; and reading the selected data unit in response to the request to transmit and transmitting the data unit. If the request to transmit the data unit has been received after the management information was transmitted, the step of transmitting the data unit includes transmitting at least a piece of the newest management information with the data unit selected by the request to transmit.

Another method according to the present invention is carried out by a client device for use with a server device in a movie distribution system. The server device records a movie and stores not only movie data, made up of predetermined data units, but also management information in which a playback duration and a data size are associated with each other with respect to each said data unit. The method includes the steps of: sending the server device a request to get the management information; receiving the management information from the server device that has responded to the request to get; finding a data unit that is needed to make a streaming playback by reference to the management information and instructing that a request to transmit be sent; receiving the data unit from the server device that has responded to the request to transmit; and playing back the movie based on the data unit received. The step of receiving the data unit includes receiving not only the data unit but also at least a piece of the newest management information from the server device.

Effects of the Invention

In a movie distribution system according to the present invention, a server device transmits not only the movie data but also the difference of the newest management information to a client device. That is why when making a streaming playback of the movie being recorded, the client device can carry out a special playback of those portions that have been updated after the streaming playback was started. Also, even if the attribute information of the movie being recorded changed during the recording operation, the client device can also continue the streaming playback operation.

### BRIEF DESCRIPTION OF DRAWINGS

FIG. 1 shows a data structure for an MPEG2 program stream 1 compliant with the VR standard.

FIG. 2 shows the data structure of a video pack in the program stream 1.

FIG. 3 shows the configuration of a movie distribution system 100 according to the present invention.

FIG. 4 shows an exemplary hardware arrangement for the server device 101.

FIG. 5 shows an exemplary hardware arrangement for the client device 102.

FIG. 6 shows the arrangements of functional blocks in the server device 101 and the client device 102.

FIG. 7(a) shows the data structure of management information 405 according to a first preferred embodiment of the present invention and FIG. 7(b) shows an example of management information 405 consisting of information about GOPs.

FIG. 8 shows the sequence of a streaming playback process.

FIG. 9 shows exemplary management information 905 according to a second preferred embodiment of the present invention.

FIG. 10 shows the data structure of a transport stream 20.

FIG. 11(a) shows the data structure of a video TS packet 30 and FIG. 11(b) shows the data structure of an audio TS packet 31.

Portions (a) to (d) of FIG. 12 show the makeup of a stream when video pictures are played back from video TS packets.

Portions (a) through (e) of FIG. 13 show a correlation between a transport stream and a clip AV stream.

FIG. 14 shows exemplary management information (EP_MAP) for the clip AV stream 52.

FIG. 15 shows a correlation between the presentation time and the source packet number.

### DESCRIPTION OF REFERENCE NUMERALS

100 movie distribution system
101 server device
102 client device
103 network
310 display
401 request reception processing section
402 request processing section
403 transmission processing section
404 movie recording processing section
405 management information
406 MPEG-2 movie
407 request sending processing section
408 streaming playback control section
409 reception processing section
410 movie output processing section
411 management information buffer
412 MPEG-2 data buffer
413 transmission data
414 MPEG-2 data
415 management information update difference
416 event information

### BEST MODE FOR CARRYING OUT THE INVENTION

Hereinafter, preferred embodiments of the present invention will be described with reference to the accompanying drawings.

### Embodiment 1

A movie distribution system, which is designed to make a server device distribute movie data to a client device over a network, will be described as a first specific preferred embodiment of the present invention. First of all, the data structure of the movie data to distribute will be described, and then the functions and operations of respective components of the movie distribution system will be described. In the following description, the “movie” will refer to a content that includes both video and audio (i.e., a broadcast program). However, the data to be distributed over the network needs to include at least one of video and audio, not necessarily both.

In this preferred embodiment, an MPEG-2 program stream compliant with the DVD Video Recording standard (which will be referred to herein as the “VR standard”) will be described as exemplary movie data. The VR-compliant MPEG-2 program stream has a data structure that can be used effectively to record a movie in real time on a recordable/rewritable DVD, for example. Thus, the server device is supposed to record a movie and distribute the recorded movie both as a VR-compliant MPEG-2 program stream.

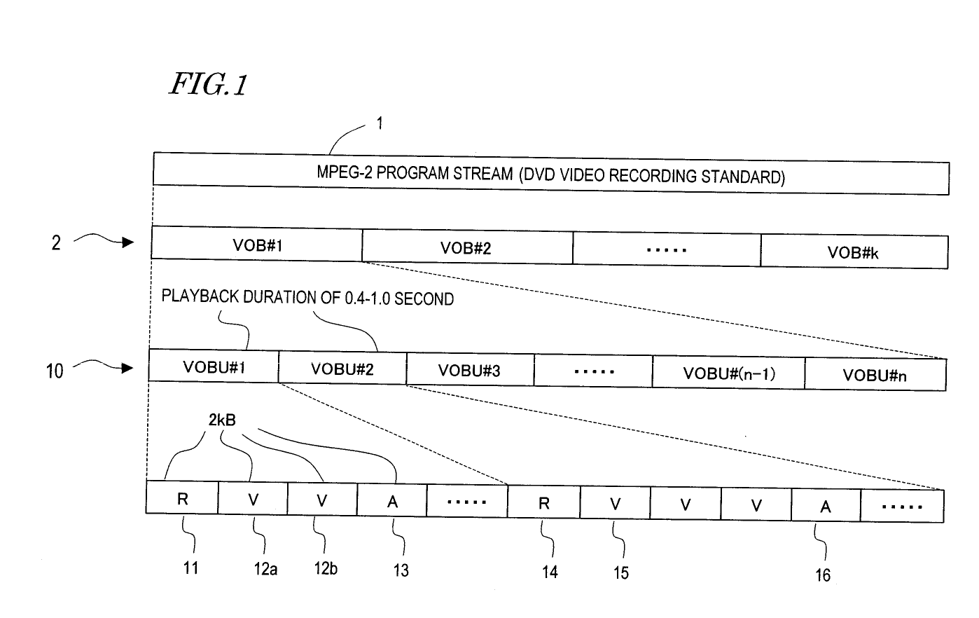

FIG. 1 shows a data structure for an MPEG2 program stream 1 compliant with the VR standard (which will be simply referred to herein as a “program stream 1”).

The program stream 1 includes a plurality of video objects (VOBs) #1, #2, . . . , and #k (all of which are collectively identified by the reference numeral 2). Supposing the program stream 1 is a recorded content, for example, each VOB stores movie data that was generated during a single video recording session (i.e., since the user started recording the video and until he or she stopped doing it).

Each VOB includes a plurality of VOB units (VOBUs) #1, #2, . . . , and #n (all of which are collectively identified by the reference numeral 10). Each VOBU is a data unit containing data with a video playback duration of about 0.4 second to about 1 second. Hereinafter, the data structure of VOBUs will be described with the first and second video object units VOBU #1 and VOBU #2 taken as an example.

VOBU #1 is composed of a number of packs. In the program stream 50, each pack has a fixed data length (also called a “pack length”) of 2 kilobytes (i.e., 2,048 bytes). At the top of the VOBU, a real time information pack (RDI pack) 11 is positioned as indicated by “R” in FIG. 1. The RDI pack 11 is followed by multiple video packs “V” (including video packs 12a and 12b) and multiple audio packs “A” (including audio pack 13).

Each pack stores the following information. The RDI pack 11 stores various information for controlling the playback of the program stream 1, e.g., information representing the playback timing of the VOBU and information for controlling copying of the program stream 1. The video packs 12a, 12b store MPEG2-compressed video data thereon. The audio packs 13 store audio data that was compressed so as to comply with the MPEG2 Audio standard, for example. In adjacent video and audio packs, video and audio data to be played back synchronously with each other may be stored. However, those packs may be arranged in any order.

VOBU #2 is also made up of a plurality of packs. An RDI pack 14 is placed at the top of VOBU #2, and then followed by a plurality of video packs 15 and a plurality of audio packs 16. The contents of the information to be stored in each of these packs are similar to those of VOBU #1.

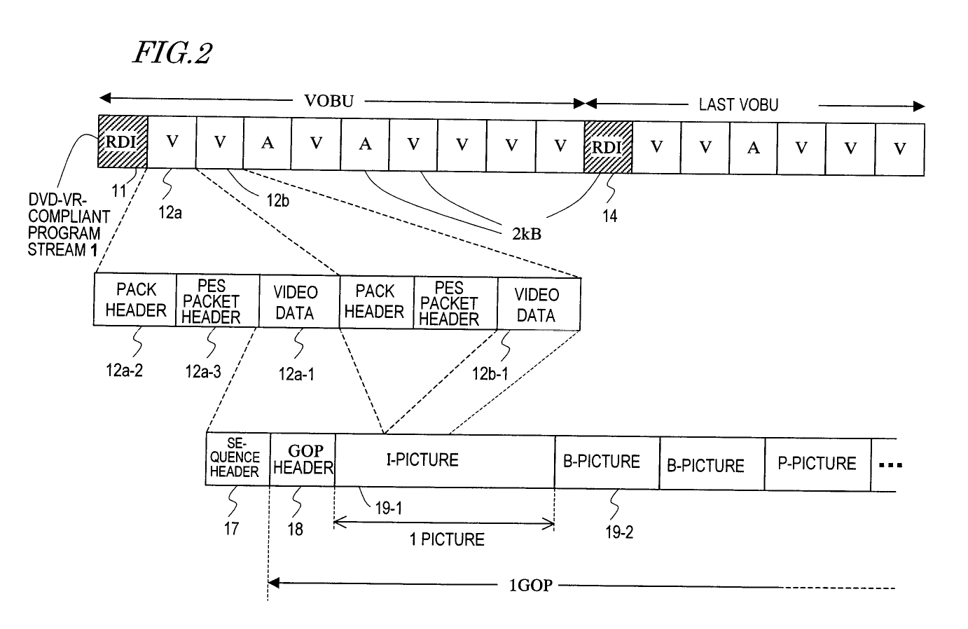

FIG. 2 shows the data structure of a video pack in the program stream 1. Hereinafter, the video packs 12a and 12b will be taken as an example. The video pack 12a stores MPEG2-compressed video data 12a-1 therein. The video pack 12a further includes a pack header 12a-2 and a PES packet header 12a-3 showing the identity as a video pack. Also, if the video pack 12a is the first one of the VOBU, a system header (not shown) is further included in the pack header 12a-2.

The video data 12a-1 of the video pack 12a shown in FIG. 2, with the video data 12b-1 and so on of the following video packs 12b, etc., make up the data of an I-picture 19-1. After the I-picture, video packs making up a B-picture 19-2 or a P-picture are recorded continuously.

The video data 12a-1 further includes a sequence header 17 and a GOP header 18. The MPEG2 standard defines a “group of pictures (GOP)” as a group of video pictures. The GOP header 18 indicates the top of each GOP. The first picture of each GOP is always an I-picture.

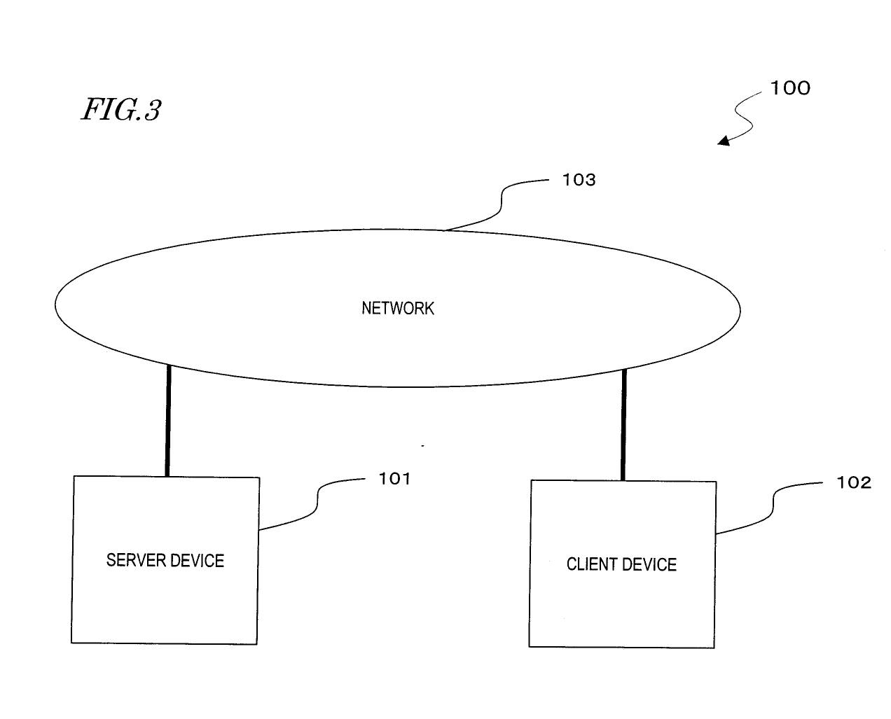

Next, a network configuration according to this preferred embodiment will be described with reference to FIG. 3, which shows the configuration of a movie distribution system 100 according to this preferred embodiment. The movie distribution system 100 is established by connecting a server device 101 and a client device 102 together over a network 103. In this movie distribution system 100, the client device 102 sends the server device 101 a request to make a streaming playback of the AV data (i.e., the program stream 1) retained in the server device 101. In response to this request, the server device 101 transmits the program stream 1 over the network 103. The client device 102 then receives the program stream 1 and plays it back sequentially, thereby making a streaming playback of it. The network 103 may be the Internet or a home LAN, for example.

One of the prime features of this movie distribution system 100 lies in that in an environment where the server device 101 is recording a movie while the client device 102 is making a streaming playback of the movie, the server device 101 sends not only the movie data but also the difference of the management information that is needed to make a special playback to the client device 102. As used herein, the “difference of the management information” refers to portions of the management information that have been updated after the movie data was transmitted last time and until movie data is transmitted next time. As a result, the client device 102 can make a special playback (such as a fast forward playback or a fast rewind playback) of the movie being recorded. In addition, the client device 102 may have a reduced RAM capacity, which is also advantageous when the client device 102 is actually set up.

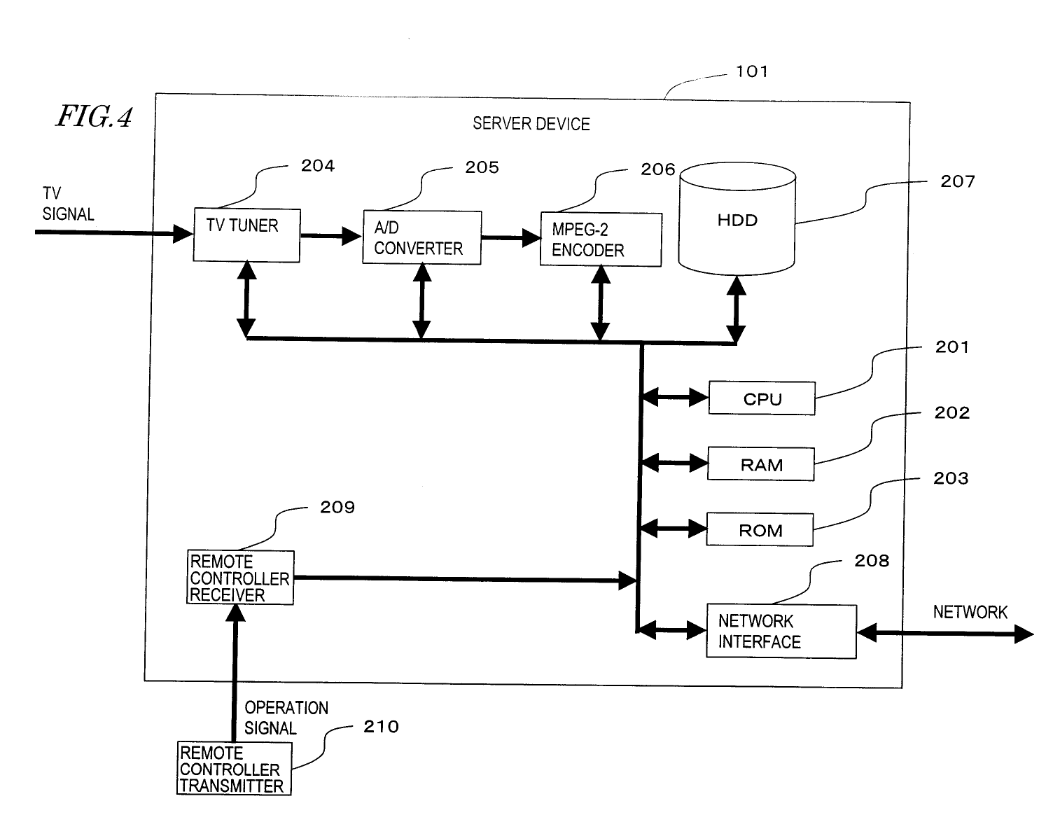

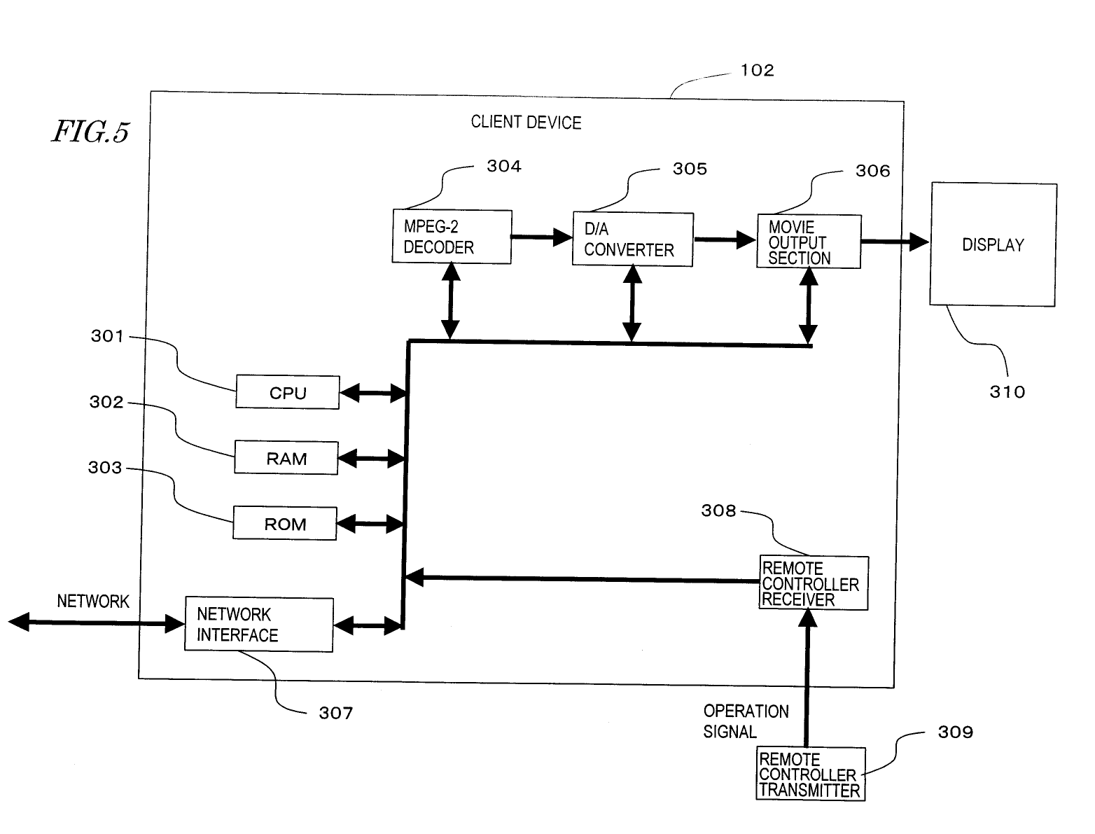

FIG. 4 shows an exemplary hardware configuration for the server device 101. The server device 101 includes a CPU 201, a RAM 202, a ROM 203, a TV tuner 204, an A/D converter 205, an MPEG-2 encoder 206, a hard disk drive (HDD) 207, a network interface 208 and a remote controller receiver 209. A remote controller transmitter 210 is also shown in FIG. 4. But actually this is an input device for use in remote control and provided separately from the server device 101.

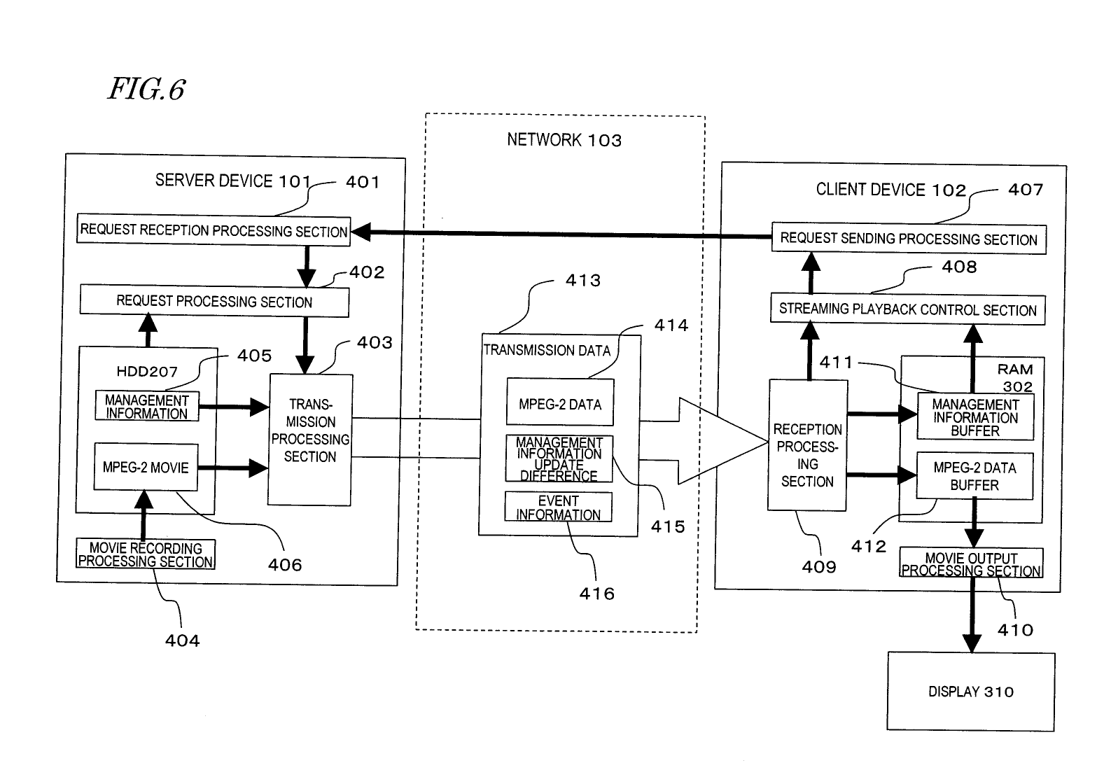

The respective components of the server device 101, and eventually the overall device itself, can be operated mainly by making the CPU 201 expand the program stored in the ROM 203 on the RAM 202 and then execute it. Their functions will be described more fully later with reference to FIG. 6.

The TV tuner 204 receives an analog TV signal, for example, and extracts only a signal transmitted from a particular TV station. This TV signal ordinarily includes respective signal components representing video and audio (i.e., movie). The extracted signal is an analog signal.

The A/D converter 205 converts the extracted analog signal into a digital signal. The MPEG-2 encoder 206 compresses and encodes the digital signal so as to comply with the MPEG-2 standard, thereby generating a program stream 1. As to video data, the MPEG-2 encoder 304 compresses and encodes the digital video signal following the MPEG-2 standard, thereby obtaining picture data. Then, the MPEG-2 encoder 206 turns that picture data into packs with the data structure shown in FIG. 2, thereby generating the program stream 1. Optionally, the MPEG-2 encoder 206 may perform only the compression coding process and then the CPU 201 may generate a program stream from the compressed and encoded video and/or audio data.

The HDD 207 sequentially stores the generated program stream 1 onto a hard disk. The network interface 208 is a network terminal for connecting this device to Ethernet™, for example, and connects the server device 101 to the network 103.

When the user inputs his or her command to be executed by the server device 101 using the remote controller transmitter 210, the remote controller transmitter 210 outputs a command signal representing the user's command. On receiving the command signal, the remote controller receiver 209 passes that signal to the CPU 201. In response, the CPU 201 instructs a type of processing to be done in accordance with the command signal. Optionally, the remote controller transmitter 210 may be replaced with an input button on the server device 101. Even by pressing the input button, a command signal representing the user's command can also be input to the server device 101.

FIG. 5 shows an exemplary hardware configuration for the client device 102. The client device 102 includes a CPU 301, a RAM 302, a ROM 303, an MPEG-2 decoder 304, a D/A converter 305, a movie output section 306, a network interface 307, a remote controller receiver 308, a remote controller transmitter 309 and a display 310. The remote controller transmitter 309 is shown in FIG. 5. But actually this is an input device for use in remote control and provided separately from the client device 102.

The respective components of the client device 102, and eventually the overall device itself, can be operated mainly by making the CPU 301 expand the program stored in the ROM 303 on the RAM 302 and then execute it. Their functions will be described more fully later with reference to FIG. 6.

The MPEG-2 decoder 304 extracts video data and audio data from the program stream, decodes those data, and then outputs them as a movie. As to video data, the MPEG-2 decoder 304 extracts picture data from the program stream according to the hierarchy shown in FIGS. 1 and 2 and then decodes the picture data so as to comply with the MPEG-2 standard. The D/A converter 305 outputs a digital signal representing the movie to the external display 310. The network interface 307 is a network terminal for connecting this device to Ethernet™, for example, and connects the client device 102 to the network 103.

When the user inputs his or her command to be executed by the client device 102 using the remote controller transmitter 309, the remote controller transmitter 308 outputs a command signal representing the user's command. On receiving the command signal, the remote controller receiver 308 passes that signal to the CPU 301. In response, the CPU 301 instructs a type of processing to be done in accordance with the command signal. Optionally, the remote controller transmitter 309 may be replaced with an input button on the client device 102. Even by pressing the input button, a command signal representing the user's command can also be input to the client device 102.

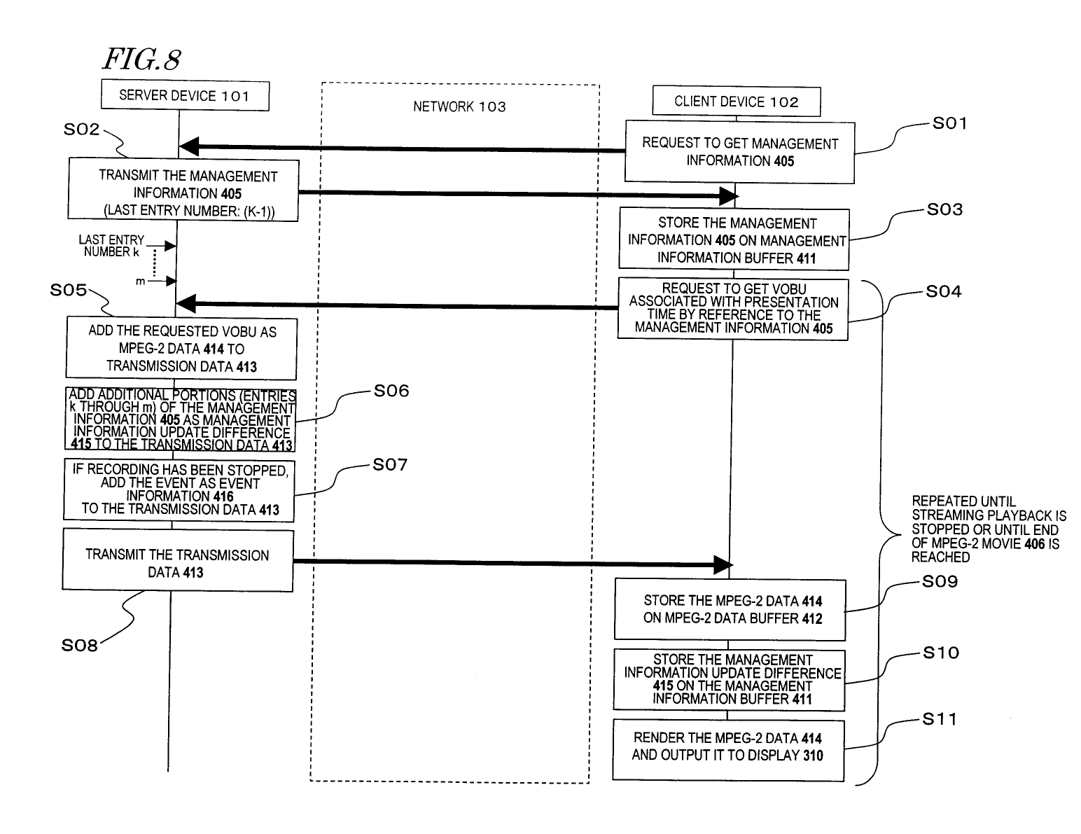

FIG. 6 shows an arrangement of functional blocks for the server device 101 and the client device 102. The functional blocks of the server device 101 are implemented by getting a computer program executed by the CPU 201 of the server device 101 shown in FIG. 4 and by operating its respective components including the CPU 201. In the same way, the functional blocks of the client device 102 are implemented by getting a computer program executed by the CPU 301 of the client device 102 shown in FIG. 5 and by operating its respective components including the CPU 301. The procedure of the processing to be done by getting the computer programs executed by the server device 101 and the client device 102 will be described later with reference to FIG. 8. It should be noted that the computer programs may be stored on a storage medium such as a CD-ROM and circulated on the market or may be downloaded through telecommunications lines (e.g., over the Internet). Thus, a data processor such as a PC may operate as a device with the same function as the server or client device described above.

The server device 101 includes a request reception processing section 401, a request processing section 402, a transmission processing section 403, and a movie recording processing section 404. Management information 405 and MPEG-2 movie data 406 are stored on an HDD 207. Meanwhile, the client device 102 includes a request sending processing section 407, a streaming playback control section 408, a reception processing section 409, and a movie output processing section 410. A management information buffer 411 and an MPEG-2 data buffer 412 are provided in the RAM 302 of the client device 102. In FIG. 6, the data transmitted from the transmission processing section 403 of the server device 101 to the reception processing section 409 of the client device 102 is referred to as “transmission data 413”. The transmission data 413 includes MPEG-2 data 414, a management information update difference 415, and event information 416. The MPEG-2 data 414 is a portion of the MPEG-2 movie data 406 and is supposed to be data of one VOBU. The management information update difference 415 and event information 416 will be described in detail later when the procedure of the processing is described fully.

First, it will be described how the server device 101 performs video recording processing. When the user inputs a command to start video recording, the movie recording processing section 404 gets the received TV signal converted into an analog movie signal by the TV tuner 204 and then gets the analog movie signal converted into a digital movie signal by the A/D converter 205. Thereafter, the digital movie signal is compressed by the MPEG-2 encoder 206 into MPEG-2 data, which is then stored as MPEG-2 movie data 406 on the HDD 207. A series of operations of this video recording processing are repeatedly carried out until the user inputs a command to stop video recording.

In addition, the movie recording processing section 404 stores not only the MPEG-2 movie data 406 but also information needed to make a special playback of the MPEG-2 movie data 406 (i.e., the management information 405) on the HDD 207.

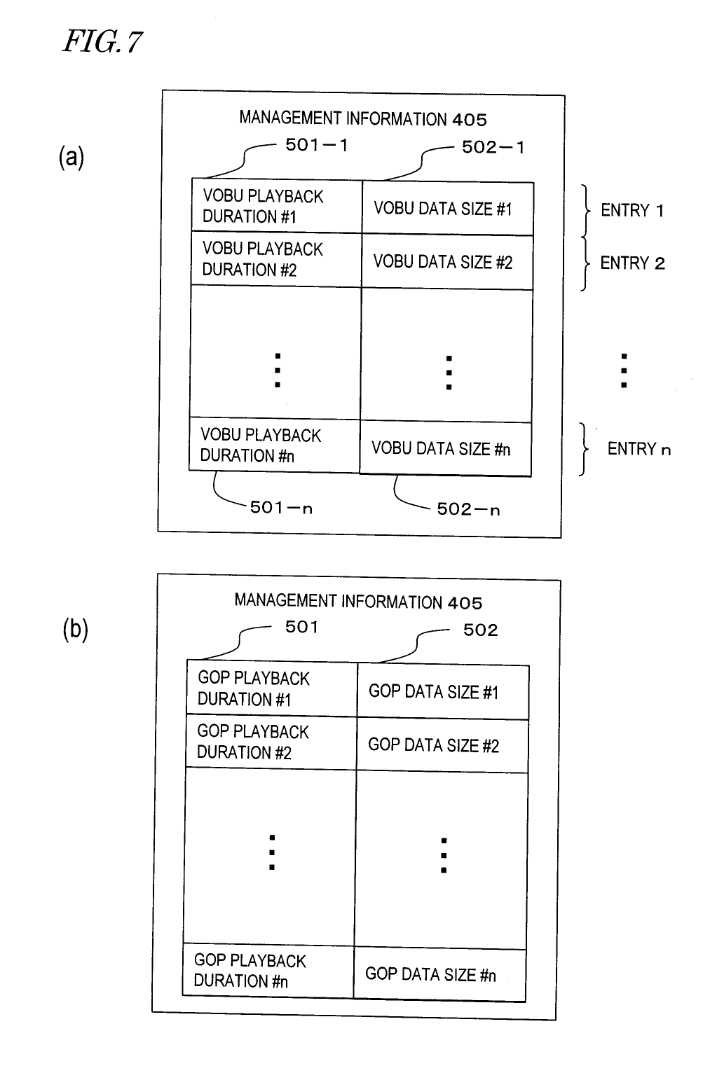

FIG. 7(a) shows the data structure of the management information 405, which includes VOBU playback durations 501-1 through 501-n and VOBU data sizes 502-1 through 502-n. The VOBU playback duration represents the video playback duration of each VOBU. The VOBU data size represents the data size of each VOBU. The values representing the playback duration and data size of each VOBU are stored in association with each other. Each associated set of VOBU playback duration and VOBU data size will be referred to herein as an “entry”. For example, Entry #1 consists of VOBU playback duration 501-1 and VOBU data size 502-1. Likewise, Entry #n consists of VOBU playback duration 501-n and VOBU data size 502-n.

The entries included in the management information 405 are provided for all VOBUs of the MPEG-2 movie data 406. That is to say, if the MPEG-2 movie data 406 includes a number n of VOBUs, then the management information 405 also includes the same number n of entries. Every time a VOBU of the MPEG-2 movie data 406 is generated, the movie recording processing section 404 sequentially records the VOBU playback duration 501 and the GOP data size 502 of that VOBU on the HDD 207. Optionally, the management information 405 may be TMAP information included in navigation data defined by the VR standard.

Each entry of this management information 405 contains information about its associated VOBU. However, this is just an example. Alternatively, the information about a VOBU may be replaced with information about a group of pictures (GOP) as shown in FIG. 2. FIG. 7(b) shows an example of management information 405 consisting of information about GOPs. In this case, GOP playback durations 501 may be defined instead of the VOBU playback durations and GOP data sizes 502 may be defined instead of the VOBU data sizes.

Hereinafter, it will be described how the client device 102 can make a streaming playback of a movie that is being recorded by the server device 101.

FIG. 8 shows the sequence of the streaming playback process. First, the user commands the client device 102 to make a streaming playback. The streaming playback control section 408 of the client device 102 instructs the request sending processing section 407 to get the management information 405 associated with the MPEG-2 movie data 406 that has been requested by the user. In accordance with the instruction, the request sending processing section 407 sends out a request to get the management information 405 to the request reception processing section 401 by the HTTP GET method (in Step S01).

On receiving the request, the request reception processing section 401 of the server device 101 instructs the request processing section 402 to read the management information 405 from the HDD 207. In accordance with this instruction, the request processing section 402 reads the management information 405 and transfers it to the transmission processing section 403. At this point in time, the management information 405 is supposed to include Entries #1 through # (k−1). The request processing section 402 memorizes the last entry number (k−1) at this point in time. Thereafter, the transmission processing section 403 transmits the management information 405 as the response of the GET method to the reception processing section 409 of the client device 102 (in Step S02). On receiving the management information 405, the reception processing section 409 of the client device 102 stores the management information 405 on the management information buffer 411 (in Step S03).

After that, the streaming playback control section 408 of the client device 102 starts to get the MPEG-2 movie data 406. It should be noted that in this processing step, the streaming playback control section 408 cannot get all of the MPEG-2 movie data 406 at a time. By reference to the management information 405 stored in the management information buffer 411, the streaming playback control section 408 calculates the address of each VOBU included in the MPEG-2 movie data 406 based on the VOBU playback duration 501 and the VOBU data size 502. Then, the streaming playback control section 408 instructs the request sending processing section 407 to get required VOBUs for playback at appropriate presentation times on a VOBU basis. As used herein, the “address of each VOBU” is a piece of data storage location information showing at what bit location each VOBU starts as counted from the beginning of the MPEG-2 movie data 406.

The request sending processing section 407 sends out a request to get the VOBU to the request reception processing section 401 of the server device 101 by the HTTP GET method (in Step S04). In this processing step, the address of the VOBU is specified by the RANGE header of the GET method.

This VOBU getting process is applicable for use in various playback methods. For example, if the user wants to play back a movie being recorded from the beginning, then the streaming playback control section 408 instructs that the movie data be got from the very first VOBU. On the other hand, if the user wants to play back a movie being recorded from a particular scene, then the streaming playback control section 408 instructs that the movie data be got from a VOBU including that scene. Furthermore, if the user wants to play back a movie at 2× rate, the streaming playback control section 408 instructs that the next VOBU be got when a half of the scheduled playback duration of a given VOBU is gone. The first and second examples are normal playback operations but the third example is a so-called special playback. In the third example, the playback rate is supposed to be 2×. However, any other playback rate may be adopted, too, and the streaming playback control section 408 may request VOBUs intermittently at an interval corresponding to the playback rate adopted.

As can be seen easily from these examples, any VOBU may be got at any time according to the user's command. As a result, a special type of playback operation may be carried out during the streaming playback.

On receiving the request to get a VOBU from the request sending processing section 407 of the client device 102, the request reception processing section 401 of the server device 101 instructs the request processing section 402 to read MPEG-2 data corresponding to the VOBU from the HDD 207. In accordance with this instruction, the request processing section 402 reads the MPEG-2 data and then transfers it to the transmission processing section 403. In response, the transmission processing section 403 generates transmission data 413 as a response message of the GET method and adds the MPEG-2 data as the MPEG-2 data 414 to the transmission data 413 (in Step S05).

Hereinafter, it will be described how to make a streaming playback of the MPEG-2 movie data 406 being recorded. The MPEG-2 movie data 406 being recorded is updated over and over again until the video recording operation is stopped in response to a user's command, for example. Accordingly, the management information 405 associated with the MPEG-2 movie data 406 also continues to be updated a number of times. In the example shown in FIG. 8, the last entry number of the management information 405 changes from k into m after the management information 405 was transmitted in Step S02 and before the request to get the VOBU is received in Step S05.

Meanwhile, only the non-updated management information 405 of Entry #(k−1) is stored in the management information buffer 411 of the client device 102. The streaming playback control section 408 requests the MPEG-2 data 414 by reference to the management information stored in the management information buffer 411. That is why the streaming playback control section 408 cannot request portions of the MPEG-2 movie data 406 that have been updated after the streaming playback was started.

To overcome this problem, when the management information 405 is updated, the request processing section 402 transmits not only the MPEG-2 data 414 but also the update difference of the management information 405 to the transmission processing section 403 of the client device 102. As used herein, the “update difference” of the management information 405 refers to a portion of the management information, which has entry number(s) following the last entry number of the management information 405 that was transmitted to the client device 102 last time till the last entry number just before the MPEG-2 data 414 is transmitted to the reception processing section 409 of the client device 102. In the example shown in FIG. 8, the update difference of the management information 405 corresponds to a portion from the entry number k to the entry number m.

The transmission processing section 403 adds the update difference as the management information update difference 415 to the transmission data 413 (in Step S06). Also, when the video recording operation is stopped, the request processing section 402 notifies the transmission processing section 403 of the event of stopped video recording. In response to this notification, the transmission processing section 403 adds information showing the stop of recording as event information 416 to the transmission data 413 (in Step S07). In this case, the transmission data 413 becomes a multipart message. As used herein, the “multipart message” is a message to be transmitted in multiple parts. In the multipart message, the border between two adjacent parts is defined by a declared predetermined character string called a “boundary”, and one part is distinguishable from the other parts. The transmission processing section 403 transmits the update difference of the management information and the movie data as a mixture in a single TCP session. Thus, there is no need to have processing(s) for the reception processing section 409 of the client device 102 to manage a plurality of TCP sessions in connection with the update difference processing. As a result, the RAM capacity that is usually reserved for this type of processing can be cut down. Having added those data to the transmission data 413, the transmission processing section 403 of the server device 101 transmits the transmission data 413 to the reception processing section 409 (in Step S08).

On receiving the transmission data 413, the reception processing section 409 of the client device 409 extracts the MPEG-2 data 414 from the transmission data 413 and stores it on the MPEG-2 data buffer 411 (in Step S09). Also, when identified the transmission data 413 as a multipart message and sensed that the management information update difference 415 is included in the message, the reception processing section 409 extracts the management information update difference 415 from the transmission data 413 and adds the management information update difference 415 to the management information buffer 411, thereby updating the management information 405 stored in the management information buffer 411 (in Step S10) As a result, the streaming playback control section 408 can also request to get the MPEG-2 data 414 for those portions of the MPEG-2 movie data 406 that have been updated after the streaming playback operation was started. Also, if the event information 416 is included in the transmission data 413, then the streaming playback control section 408 extracts the event information 416 from the transmission data 413 and transfers it to the streaming playback control section 408.

The streaming playback control section 408 transfers the MPEG-2 data 414 from the MPEG-2 data buffer 411 to the movie output processing section 410. In response, the movie output processing section 410 performs predetermined processing on the MPEG-2 data 414, thereby outputting video and audio (i.e., movie) to the external display 310 (in Step S11). The processing of the movie output processing section 410 is actually done by getting the MPEG-2 data 414 expanded by the MPEG-2 decoder 304 into a digital movie signal, getting the digital movie signal converted into an analog movie signal by the D/A converter 305, getting the analog movie signal drawn by the movie output section 306 and then outputting it to the external display 310.

In the streaming playback, the processing steps S04 through S11 are repeatedly carried out over and over again until the user inputs a command to stop the streaming playback or until the end of the MPEG-2 movie data 406 is reached. If the MPEG-2 movie data 406 is being recorded when the streaming playback is started, then the streaming playback control section 408 of the client device 402 senses, by the event information 416, that the recording of the MPEG-2 movie data 406 has been stopped, thereby detecting the end of the MPEG-2 movie data 406. Even when the recording operation is brought to a brief pause, the streaming playback control section 408 also receives a similar notification, thereby recognizing that state.

In the foregoing description, the server device 101 does not have the function of playing back the MPEG-2 movie data 406 that is stored on the HDD 207. However, the server device 101 may have that function. The client device 102 does not have the function of recording the MPEG-2 movie on a storage medium such as a HDD, either, but may have that function.

### Embodiment 2

A process of handling distributed movie data even when the video being recorded changes its resolutions will be described as a second preferred embodiment of the present invention.

The movie distribution system 100 of this preferred embodiment also has the same overall configuration as that shown in FIG. 3. Also, the server device 101 and client device 102 have the same hardware configurations and the same arrangements of functional blocks as those shown in FIGS. 4 through 6. These configurations and arrangements have already been described for the first preferred embodiment and the description thereof will be omitted herein.

When the movie recording processing section 404 is writing an analog broadcast signal, for example, as MPEG-2 movie data 406, the attributes of the movie such as the resolution and the number of audio channels may change. Particularly if the movie changes its attributes before and after the management information is updated by the client device 102, then the client device 102 cannot sense the change and the decoding process may fail.

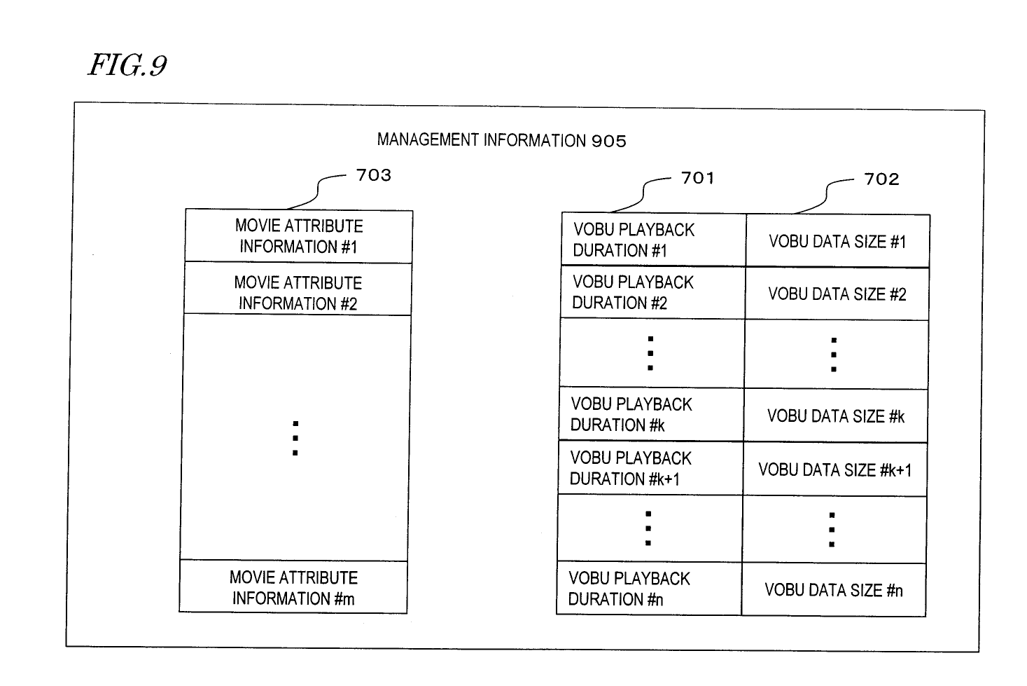

That is why the movie recording processing section 404 of the server device 101 generates movie attribute information 703 and sequentially writes it as pieces of the management information on the HDD 207. FIG. 9 shows exemplary management information 905 according to this preferred embodiment. The management information 905 includes a VOBU playback duration 701, a VOBU data size 702 and movie attribute information 703. The contents of the VOBU playback duration 701 and the VOBU data size 702 are substantially the same as those shown in FIG. 5(a) and the description thereof will be omitted herein. The movie attribute information 703 is information that specifies the attributes of a movie such as the resolution and the number of audio channels. In this preferred embodiment, the management information 905 is made up of multiple entries, each consisting of the VOBU playback duration 701, VOBU data size 702 and movie attribute information 703. It should be noted that the management information 905 does not always have to include the movie attribute information. Alternatively, the movie attribute information may be added to only some entries associated with VOBUs with varied attributes. The movie attribute information 703 may be a copy of the information included in the navigation data as defined by the DVD-VR standard (i.e., M_VOB_STI information).

The sequence in which the client device 102 makes a streaming playback of a movie being recorded by the server device 101 is basically the same as that shown in FIG. 8. Thus, the same sequence is applicable to this preferred embodiment just by replacing the management information with the management information 905 of this preferred embodiment. However, in Step S04, the streaming playback control section 408 of the client device 102 gets the attribute information of the MPEG-2 movie data 406 by reference to the movie attribute information 703 included in the management information 905 and then performs a playback process in accordance with that attribute information. Also, if the attribute information of the MPEG-2 movie data 406 changes during the video recording operation, then the request processing section 402 transfers the newly generated movie attribute information 703 in Step S06 to the transmission processing section 403, which in turn transmits the movie attribute information 703 combined with the management information update difference 415. As a result, even if the attribute information of the MPEG-2 movie data 406 being recorded has changed, the client device 102 can still get the updated movie attribute information 703 and therefore can continue to make the streaming playback.

In the preferred embodiments of the present invention described above, the video recording operation by the server device 101 is supposed to be realized by generating an MPEG-2 program stream from an analog TV signal, for example, and writing it on the HDD 207. Optionally, however, the server device 101 may receive an MPEG-2 transport stream, which is adopted in a digital telecasting, subject the stream to a predetermined process, and then write it on either the HDD 207 or a Blu-ray disc (BD). A BD is an optical disk from/on which data can be read and written using a laser beam with a wavelength of about 405 nm and which has a capacity of about 25 GB per storage layer.

In this case, the MPEG-2 transport stream is written while maintaining its packet structure. In the following description, the MPEG-2 transport stream is supposed to be written on the HDD 207.

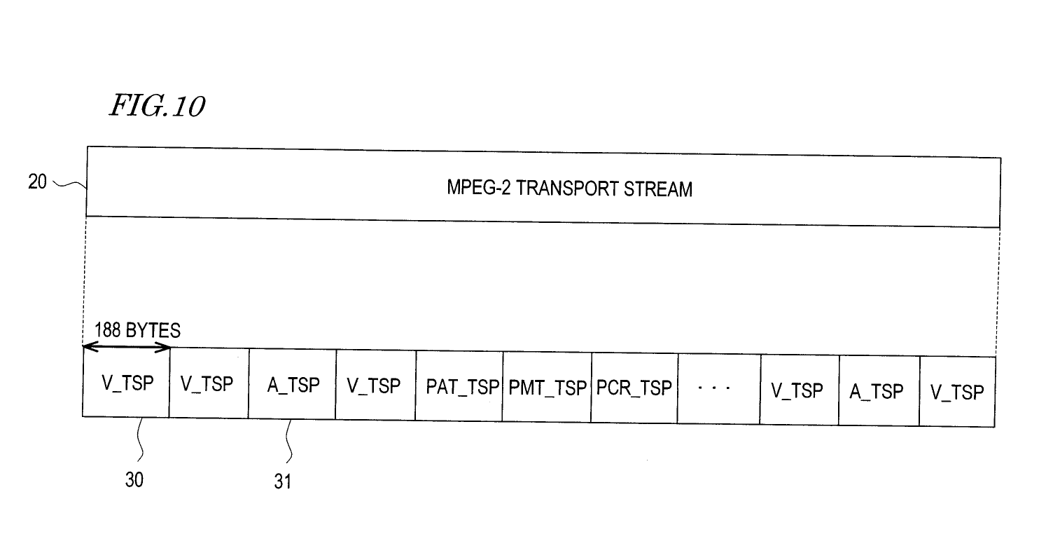

Thus, the data structure of an MPEG-2 transport stream to be transmitted as a digital broadcasting wave will be described with reference to FIGS. 10 to 13. It should be understood from the following description that what was described for the first and second preferred embodiments that use the program stream 1 is also applicable to an MPEG-2 transport stream. In the following description, the “MPEG-2 transport stream” will be simply referred to herein as a “transport stream” or “TS”.

FIG. 10 shows the data structure of a transport stream 20. The transport stream 20 includes a plurality of transport packets, each having a packet length of 188 bytes. Examples of those TS packets include a video TS packet (V_TSP) 30 in which compressed video data is stored, an audio TS packet (A_TSP) 31 in which compressed audio data is stored, a packet (PAT_TSP) in which a program association table (PAT) is stored, a packet (PMT_TSP) in which a program map table (PMT) is stored, and a packet (PCR_TSP) in which a program clock reference (PCR) is stored.

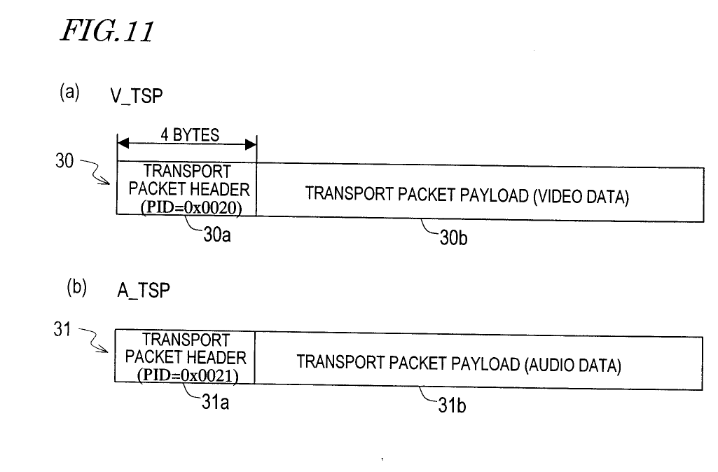

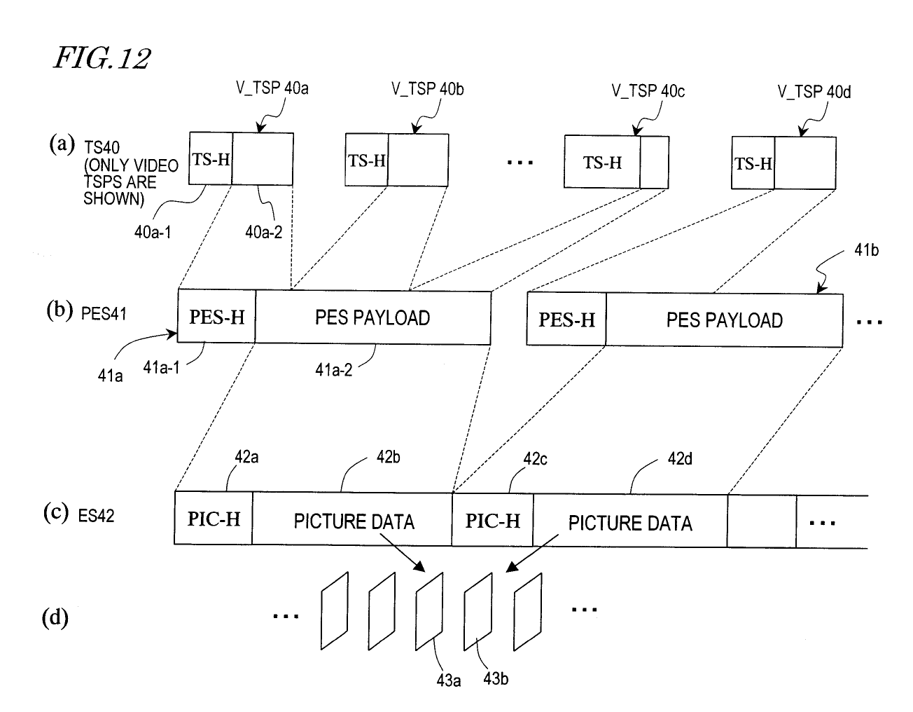

Hereinafter, the video TS packets and audio TS packets contributing to the processing of the present invention will be described. FIG. 11(a) shows the data structure of a video TS packet 30. The video TS packet 30 includes a transport packet header 30a of 4 bytes and a transport packet payload 30b of 184 bytes in which video data 30b is stored. On the other hand, FIG. 11(b) shows the data structure of an audio TS packet 31. The audio TS packet 31 also includes a transport packet header 31a of 4 bytes and a transport packet payload 31b of 184 bytes, in which audio data 31b is stored.

As can be seen from this example, a TS packet usually consists of a transport packet header of 4 bytes and elementary data of 184 bytes. In the packet header, a packet identifier (PID) showing the type of that packet is described. For example, the PID of a video TS packet is 0x0020, while that of an audio TS packet is 0x0021. The elementary data may be content data such as video data or audio data or control data for controlling the playback. The type of the data stored there changes according to the type of the packet.

Hereinafter, a correlation between video data and pictures that make up the video will be described as an example. Portions (a) to (d) of FIG. 12 show the makeup of a stream when video pictures are played back from video TS packets. As shown in portion (a) of FIG. 12, this TS 40 includes video TS packets 40a through 40d. Although the TS 40 may include other packets, only those video TS packets are shown here. A video TS packet can be easily identifiable by the PID stored in its header 40a-1.

A packetized elementary stream is made up of the video data of respective video TS packets such as the video data 40a-2. Portion (b) of FIG. 12 shows the data structure of a packetized elementary stream (PES) 41. The PES 41 includes a plurality of PES packets 41a, 41b, etc. The PES packet 41a is made up of a PES header 41a-1 and a PES payload 41a-2. These data are stored as the video data of the video TS packets.

Each PES payload 41a-2 includes the data of a single picture. An elementary stream is made up of those PES payloads 41a-2. Portion (c) of FIG. 12 shows the data structure of an elementary stream (ES) 42. The ES 42 includes multiple pairs of picture headers and picture data. The headers and picture data that form the ES 42 are the same as the data of the pictures 19-1, 19-2 shown in FIG. 2. It should be noted that the “picture” is generally used as a term that may refer to either a frame or a field.

In the picture header 42a shown in portion (c) of FIG. 12, a picture coding type, showing the picture type of the following picture data 42b, is described. In the same way, a picture coding type, showing the picture type of the following picture data 42d, is described in the picture header 42c. The “type” is one of an I-picture (intra-coded picture), a P-picture (predictive-coded picture) and a B-picture (bidirectionally-predictive-coded picture). If the type shows this is an I-picture, its picture coding type may be “001b”, for example.

The picture data 42b, 42d, etc. is data corresponding to a single frame, which may consist of either that data only or that data and preceding/succeeding data to be decoded before and/or after the former data. For example, portion (d) of FIG. 12 shows a picture 43a consisting of the picture data 42b and a picture 43b consisting of the picture data 42d.

A transport stream of digital broadcasting may include video, audio and other TS packets of multiple programs in combination. That is why in recording a program, the packets needed to play back the program should be extracted. Thus, it will be described with reference to FIG. 13 how a transport stream is processed and gets stored on the HDD 207 while the server device 101 is recording a movie. In the following description, a transport stream including the TS packets of multiple programs will be referred to herein as a “full TS”, while a transport stream including only required TS packets extracted will be referred to herein as a “partial TS”.

Portions (a) through (e) of FIG. 13 show a correlation between a transport stream and a clip AV stream. Specifically, portion (a) of FIG. 13 shows a full TS 50, in which TS packets, including the data of three programs X, Y and Z, may be arranged in series, for example. Portion (b) of FIG. 13 shows a partial TS 51 that has been generated by the TV tuner 204 of the server device 101 from the full TS 50. The partial TS 51 is a stream formed by extracting some packets from the continuous full TS 50. Thus, in the partial TS 51, those packets are dispersed discretely on the time axis. However, the intervals between those packets have been adjusted by the sender of the full TS so as to satisfy the conditions to make the decoder decode appropriately. Those “conditions” are laid down by the MPEG standard such that the buffer memory of a TS system target decoder (T-STD), defined as an ideal model of an MPEG-2 TS, does not cause an overflow or underflow.

The partial TS 51 may include the TS packets about the program X, for example.

Portion (c) of FIG. 13 shows a stream (i.e., a clip AV stream) 52 to be stored on the HDD 207 of the server device 101 by rearranging the partial TS. In the clip AV stream 52, source packets are arranged continuously.

Portion (d) of FIG. 13 shows the data structure of a source packet 53, which has a fixed data length of 192 bytes. More specifically, each source packet 53 is formed by adding a TP extra header 54 of 4 bytes to the top of a TS packet 155 of 188 bytes.

Portion (e) of FIG. 13 shows the data structure of the TP extra header 54. The TP extra header 54 is made up of a copy permission indicator (CPI) 56 of 2 bits and an arrival time stamp (ATS) 57 of 30 bits. The copy permission indicator (CPI) 56 indicates, by its bit value, how many times (i.e., zero times (copy prohibited), only once or an unlimited number of times) part or all of the clip AV stream 52 may be copied. The arrival time stamp (ATS) 57 describes the point in time when the TS packet arrived at the server device 101 at a precision of 90 kHz. Such time information is added for the following reason. Specifically, the TS packets of the partial TS are written continuously on the HDD 207. Thus, to process a TS packet exactly at the arrival time of the TS packet of the partial TS during the playback operation, the information about that arrival time is needed for each packet.

It should be noted that the clip AV stream 52 shown in portion (c) of FIG. 13 is written on the HDD 207 using a set of 32 source packets (6 KB) as a unit. Such a unit is called an “aligned unit”. The aligned unit is defined because the BD 205a uses sectors each having a size of 2 KB and can align the sectors on the basis of 32 source packets.

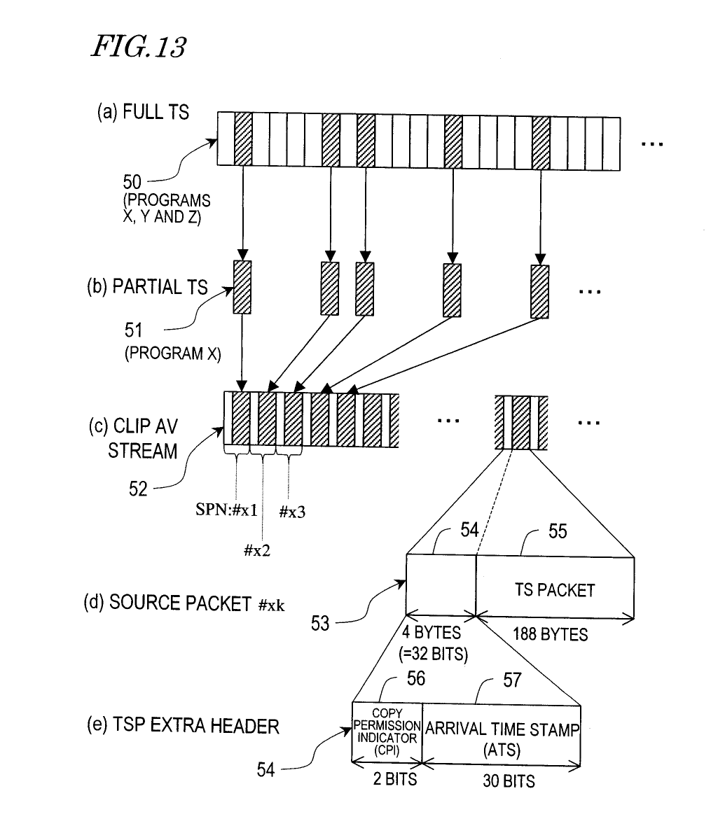

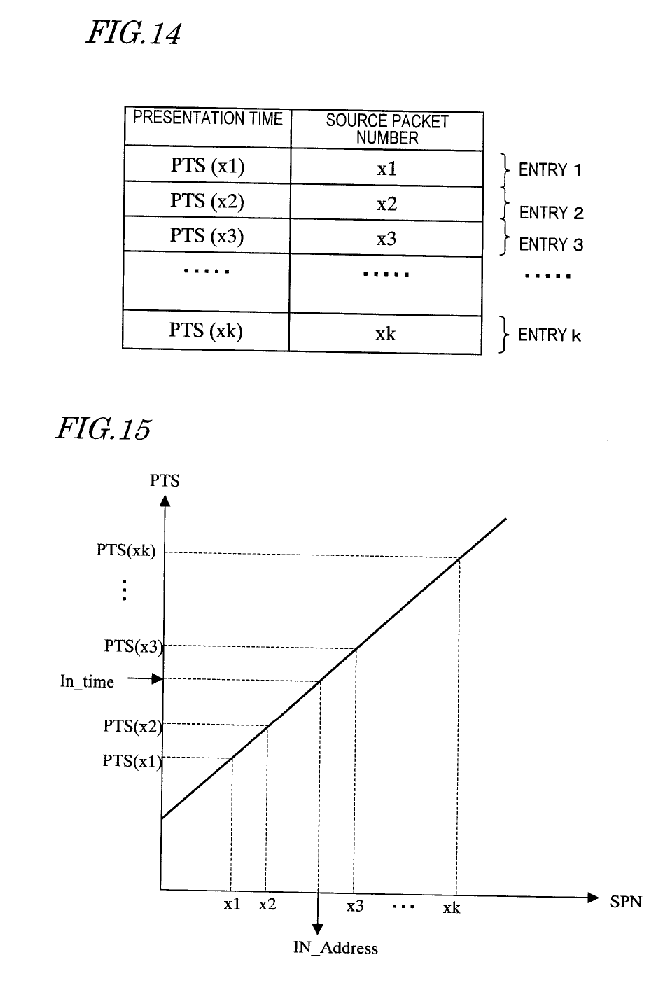

The clip AV stream 52 written on the HDD 207 of the server device 101 corresponds to the MPEG-2 movie data 406 of the first preferred embodiment described above. Meanwhile, to carry out the processing of the present invention, management information for the clip AV stream 52 is also needed. Thus, management information for the clip AV stream 52 will be described with reference to FIGS. 14 and 15.

FIG. 14 shows exemplary management information (EP_MAP) for the clip AV stream 52. This management information is an arrangement of multiple sets of presentation times and source packet numbers as entries and has a similar data structure to the management information shown in FIG. 5(a).

As to video, the presentation time stamp (PTS) represents the PTS of each I-picture arranged at the top of a GOP compliant with the MPEG standard shown in FIG. 2. Also, the source packet number (SPN) means the number of a source packet in which the top data of an I-picture to be played back at a time corresponding to the PTS is stored. The source packets have a data size of 192 bytes. Accordingly, when the source packet number is known, the number of bytes as counted from the top of the clip AV stream is also known and the data can be accessed easily and accurately. That is why the data size can be regarded as being described by the source packet number.

It should be understood that if the description about the management information and MPEG-2 movie data for the first and second preferred embodiments (e.g., the description about FIG. 8) is replaced with the description about the management information (EP_MAP) and the clip AV stream 52, then the techniques of the first and second preferred embodiments are applicable in quite the same way to even digital broadcasting that adopts transport streams. That is to say, when transmitting the clip AV stream 52 being recorded to the client device 102, the server device 101 also sends the update difference of the management information (EP_MAP) (i.e., the additional portion of the entry). As a result, the client device 102 can play back the recorded program by reference to the newest management information (EP_MAP).

The movie output processing section 410 of the client device 102 can make a special playback operation in the following manner. The “special playback” is to shift the presentation time of a picture either forward or backward by increasing the playback rate by the factor of 2 or ½, for example. Thus, to make the special playback, it is only necessary to specify the presentation time earlier or later than the normal mode.

FIG. 15 shows a correlation between the presentation time and the source packet number. The management information describes only the PTS value of each I-picture arranged at the top of a GOP. Accordingly, if the movie output processing section 410 specified another PTS value, not the PTS value at the top of the GOP, as a start time (In_time) and/or an end time (Out_time), no source packet number (address) could be obtained directly for that time. However, according to a method for compressing and encoding MPEG-2 video, the compression process is carried out by using the difference between pictures. That is why unless the I-picture at the top of a GOP is decoded first, the pictures that follow the I-picture cannot be decoded, either.

Thus, when starting a playback operation from a picture other than the I-picture at the top of a GOP, the movie output processing section 410 of the client device 102 begins the decoding process with the I-picture designated by the management information (EP_map) and starts outputting the movie from the picture at the specified time while analyzing and decoding the pictures that follow the I-picture. As a result, not only can the playback operation be started from any arbitrary point but also can the playback/output operation be started from any picture.

In FIGS. 14 and 15, the actual values of the source packet numbers X1 and X2 do not always have to be a series of integers that increase one by one but may be integers that increase regularly by a predetermined quantity.

### INDUSTRIAL APPLICABILITY

By setting up a movie distribution system consisting of server and client devices according to the present invention, even if the server device is recording, a special playback operation can still be carried out during a streaming playback. Also, even if the attribute information of a movie being recorded changes during the recording operation, the client device can still continue the streaming playback operation.

1. A server device for use with a client device in a movie distribution system, the server device comprising:
a video recording processing section for recording a movie and generating not only movie data, made up of predetermined data units, but also management information in which a playback duration and a data size are associated with each other with respect to each said data unit;
a storage medium to store the movie data and the management information thereon;
a receiving section, which receives a request to get the management information and a request to transmit the data unit from the client device;
a request processing section for reading the management information and the data unit in response to the request to get and the request to transmit, respectively, and instructing that the management information and the data unit be transmitted; and
a transmitting section for transmitting the management information and data unit instructed,
wherein if the request to transmit the data unit has been received after the management information was transmitted, the request processing section instructs that at least a piece of the newest management information be transmitted with the data unit selected by the request to transmit.

2. The server device of claim 1, wherein the request processing section instructs that a piece of the management information, which has been updated after the management information was transmitted and until the at least one data unit selected by the request to transmit is transmitted, be transmitted.

3. The server device of claim 1, wherein when the video recording processing section stops recording the movie, the request processing section instructs that a notification of the stop of recording be sent and the transmitting section sends the notification with the data unit selected by the request to transmit.

4. The server device of claim 3, wherein the transmitting section transmits at least two of: the data unit; at least the piece of the newest management information; and the notification, that are stored in separate sections of a message so as to be distinguished from each other.

5. The server device of claim 1, wherein the movie data concerns a stream compliant with one of the MPEG standards and the data unit is a video object unit.

6. The server device of claim 1, wherein the video recording processing section generates management information in which playback-related attributes of the movie are further associated with each said data unit.

7. A client device for use with a server device in a movie distribution system, the server device recording a movie and storing not only movie data, made up of predetermined data units, but also management information in which a playback duration and a data size are associated with each other with respect to each said data unit, the client device comprising:
a transmitting section for sending the server device a request to get the management information and a request to transmit the data unit;
a receiving section for receiving the management information and the data unit from the server device that has responded to the request to get and the request to transmit, respectively;
a playback control section for finding a data unit that is needed to make a streaming playback by reference to the management information and instructing that the request to transmit be sent; and
a movie output processing section for playing back the movie based on the data unit received,
wherein the receiving section receives not only the data unit but also at least a piece of the newest management information from the server device.

8. The client device of claim 7, wherein the receiving section receives a piece of the management information, which has been updated after the server device transmitted the management information in response to the request to get and until the at least one data unit selected by the request to transmit is transmitted.

9. The client device of claim 7, wherein the receiving section receives not only the data unit but also a notification of stop of recording from the server device.

10. The client device of claim 9, wherein the receiving section receives a message, in which at least two of: the data unit; at least the piece of the newest management information; and the notification, are stored, and distinguishes and retrieves the at least two of them.

11. The client device of claim 7, wherein the movie data concerns a stream compliant with one of the MPEG standards and the data unit is a video object unit.

12. The client device of claim 7, wherein the receiving section receives management information in which playback-related attributes of the movie are further associated with each said data unit, and
wherein the movie output processing section plays back the movie in accordance with the attributes and the data units.

13. A movie distribution system for allowing a client device to receive movie data, made up of predetermined data units, from a server device and to make a streaming playback of the movie,
wherein the server device includes:
a video recording processing section for recording a movie and generating not only movie data, made up of predetermined data units, but also management information in which a playback duration and a data size are associated with each other with respect to each said data unit;
a storage medium to store the movie data and the management information thereon;
a server receiving section, which receives a request to get the management information and a request to transmit the data unit from the client device;
a request processing section for reading the management information and the data unit in response to the request to get and the request to transmit, respectively, and instructing that the management information and the data unit be transmitted; and
a server transmitting section for transmitting the management information and data unit selected, and
wherein the client device includes:
a client transmitting section for sending the server device the request to get the management information and the request to transmit the data unit;
a client receiving section for receiving the management information and the data unit from the server device that has responded to the request to get and the request to transmit, respectively;
a playback control section for finding a data unit that is needed to make the streaming playback by reference to the management information and instructing that the request to transmit be sent; and
a movie output processing section for playing back the movie based on the data unit received,
wherein if the request to transmit the data unit has been received after the management information was transmitted, the request processing section of the server device instructs that at least a piece of the newest management information be transmitted with the data unit selected by the request to transmit and the client receiving section receives not only the data unit but also at least the piece of the newest management information from the server device.

14. A method to be carried out by a server device for use with a client device in a movie distribution system, the method comprising the steps of:
recording a movie and generating not only movie data, made up of predetermined data units, but also management information in which a playback duration and a data size are associated with each other with respect to each said data unit;
storing the movie data and the management information;
receiving a request to get the management information from the client device;
transmitting the management information in response to the request to get;
receiving a request to transmit the data unit that has been selected by the client device by reference to the management information transmitted; and
reading the selected data unit in response to the request to transmit and transmitting the data unit, and
wherein if the request to transmit the data unit has been received after the management information was transmitted, the step of transmitting the data unit includes transmitting at least a piece of the newest management information with the data unit selected by the request to transmit.

15. A method to be carried out by a client device for use with a server device in a movie distribution system, the server device recording a movie and storing not only movie data, made up of predetermined data units, but also management information in which a playback duration and a data size are associated with each other with respect to each said data unit, the method comprising the steps of:
sending the server device a request to get the management information;
receiving the management information from the server device that has responded to the request to get;
finding a data unit that is needed to make a streaming playback by reference to the management information and instructing that a request to transmit be sent;
receiving the data unit from the server device that has responded to the request to transmit; and
playing back the movie based on the data unit received,
wherein the step of receiving the data unit includes receiving not only the data unit but also at least a piece of the newest management information from the server device.
